(19) United States
(12) Patent Application Publication
(10) Pub. No.: US 2008/0030372 A1
(43) Pub. Date: Feb. 7, 2008

(54) Traffic light prediction system

(76) Inventor: Guixian Lu, Pontiac, MI (US)

Correspondence Address: Guixian Lu, 853 Melrose St., Pontiac, MI, 48340, US

(21) Appl. No.: 11/497,434

(22) Filed: Aug. 2, 2006

(51) Int. Cl. G08G 1/096; G08G 1/00

(52) U.S. Cl. 340/929; 340/932

(57) ABSTRACT

A traffic system that helps a driver to save gasoline by avoiding red light or by decelerating before a red light. It predicts the colors of a traffic light and informs about the future traffic light colors that will happen to a driver. The system comprising three kinds of moving sections representing three future colors: green, yellow, and red. The moving sections are moving towards the traffic light. There is a driver advisor in a vehicle displaying the positions of the vehicle, the traffic light, and the moving sections.

### BACKGROUND OF THE INVENTION

There are many traffic lights in a city. When a vehicle run into a red light, it must stop and wait until the light changes to green before it is allowed to go. This wastes fuel and causes more pollution. It wastes travel time also. That is why the hybrid vehicles are hot now, but hybrid vehicles are expensive. Hybrid vehicles lose energy in both conversion of kinetic energy to chemical energy and conversion of chemical energy to kinetic energy. Hybrid vehicles can not convert kinetic energy to chemical if the battery is fully charged.

### PRIOR ART

a. Berezovsky (U.S. Pat. No. 6,552,668) “Attachment to traffic light apparatus for visual indication of traffic light duration”
b. Seguin et al. (U.S. 2005/0102872) “Traffic-signaling system”
c. Berezovsky (U.S. Pat. No. 6,175,313) “Attachment to traffic light apparatus for visual indication of traffic light duration”
d. Safronov et al. (U.S. Pat. No. 6,310,562) “Method of indicating time remaining until traffic lights change”
e. Peorowicz et al. (U.S. Pat. No. 6,516,273) “Method and apparatus for determination and warning of potential violation of intersection traffic control devices”

### SUMMARY OF THE INVENTION

The primary objective of the present invention is to save fuel for vehicles and travel time. Other objectives are to reduce pollution from vehicles, to maximize the usage of the streets, and to reduce traffic accidents and traffic jams.

The forgoing objectives are accomplished by defining moving sections on a street, moving towards the traffic light. Usually each kind of moving section represents one future color from the traffic light. Green sections will result in arriving to a green light. Red section will result in arriving to a red light. The driver advisor will keep informing the drivers how to change the speed in order to shift from a red section to a green section.

### BRIEF DESCRIPTION OF THE DRAWING

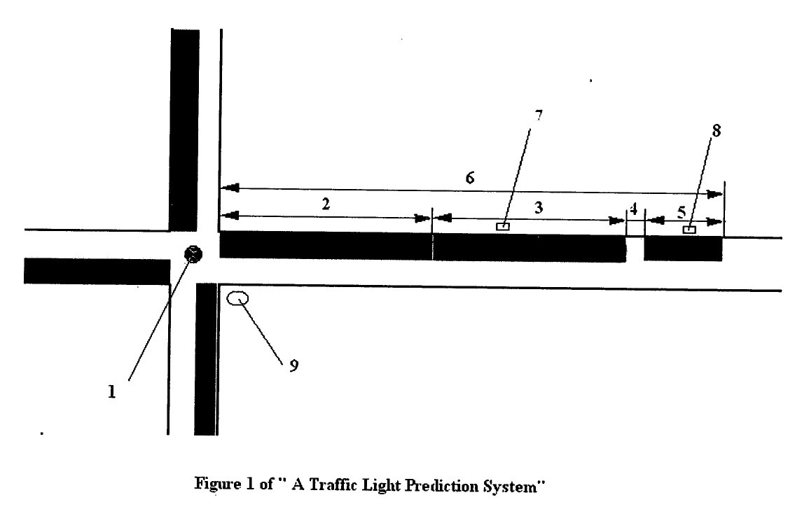

In FIG. 1: Item 1 is the traffic light. Item 2 is a red moving section. Item 3 is a green moving section. Item 4 is a yellow moving section. Item 5 is a red moving section. Item 6 is control zone that contains all the moving sections. Item 7 and 8 are communicators. Item 9 is a broadcast unit.

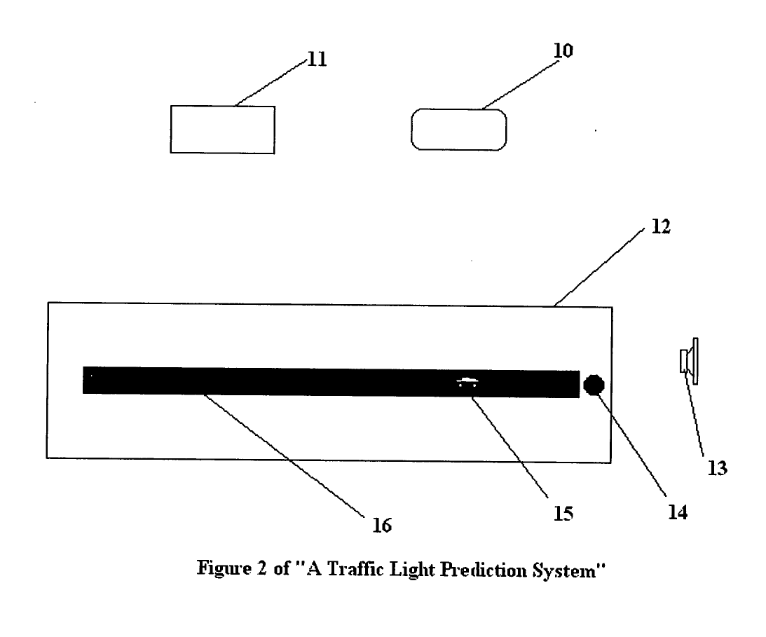

In FIG. 2: This figure shows all the parts in the driver advisor. Item 10 is a sensor or antenna. Item 11 is the microprocessor. Item 12 is the video device. Item 13 is the audio device. Item 14 is a icon for traffic light. Item 15 is an icon for vehicle. Item 16 is an icon for moving sections.

### DETAILED DESCRIPTION

The present invention defines three kinds of moving section on streets before a traffic light: red sections, green sections, and yellow sections, representing three future colors of the traffic light. There is a control zone along the length of the traffic light, comprised of moving sections. Every moving section starts from the far end of the control zone, moving towards the traffic light, and ends at the traffic light. The length of the control zone ( total length of moving sections ) is fixed and is made long enough, if possible, to give vehicles long enough time to shift from a red section to a green section before they reach the traffic light. It is not necessary, though to make the control zone that long. Usually the speed of moving sections is lower than the speed limit on the street. Length of every moving section increases from zero since it starts at the far end of the control zone. The full length of a moving section is approximately equal to speed of moving sections multiplied by the period of the color that the moving section represents. Let's say the speed is 30 mile per hour. The green light lasts 0.5 minute. The full length of a green section should be 0.25 mile. The movement of the moving sections is synchronized with the periods of the traffic light as follows: When a green section reaches the traffic light, it is about the time for the traffic light to change the color to green. When a yellow section reaches the traffic light, it is about the time for the traffic light to change the color to yellow. When a red section reaches the traffic light it is about the time for the traffic light to change the color to red. As the result of the synchronization, the moving section close to the traffic light always represents the same color as the traffic light.

There will be a tendency of filling the green section with vehicles. Drivers at the front edge of a green section would not increase speed to get into the red section. Vehicles inside a green section would move towards the front part of the green section because most of the drivers have a tendency to drive fast. As a result, this will concentrate vehicles in the front part of green sections, empty space at the rear part of green sections. Vehicles at front edge of a red section may accelerate to the yellow section or green section. This is allowed because speed of the moving sections is under speed limit. Most of the vehicles in a red section will reduce speed to save gasoline. A vehicle reducing speed may force vehicles behind it to reduce speed. As a result, this will concentrate vehicles to the rear part of a red section or force some vehicles to shift to the green section behind it, which is good for them. The fact that vehicles concentrate to green sections means saving travel time and increase usage of streets. The fact that there are fewer vehicles in red sections means less traffic jams, and less traffic accidents.

There are many streets that are not long enough for vehicles to change from one moving section to another. Some of them may not be longer than one moving section. In this case, the system is still applicable. The system will benefit the drivers as follows. If the vehicles are already moving in a green section, the system will help the driver to keep moving inside the green section. If it is impossible for the vehicles to shift from a red section to a green section, decelerate as much as possible by removing foot off gasoline pedal (not by braking) before the red light. This will save on gasoline. Let's say, canceling velocity of 50 miles per hour by braking before a red light loses 4 cents of gasoline. Then canceling velocity of 25 miles per hour by braking will lose only 1 cent of gasoline, because the kinetic energy is proportional to square of velocity. The formula is E=0.5*M*V², where E is kinetic energy; M is mass; V is velocity. Decreasing fuel consumption will reduce pollution.

### Driver Advisor Unit

The driver advisor unit has an audio device giving one of following audio advises:
a) “Stop! red light in front is close.” ( This happens only the distance is too shot for the driver to cancel the speed before the red light.)
b) “Move foot off gas petal.”
c) “Push brake petal to reduce speed to 25 (or any number) miles per hour.”
d) “Increase speed to 45 miles per hour.”
e) “It is okay now.”, meaning stop changing vehicle speed.

The video device will display the positions of the vehicle, moving sections, and the traffic light.

The inputs to the driver advisor are
a) The traffic light cycling information including:
   1. The period of green light in seconds.
   2. The period of yellow light in seconds.
   3. The period of red light in seconds.
   4. The phase of the traffic light cycle in degrees. For example, the total seconds of above periods is 120 second. Now the traffic light is at 30^{th} second. The phase is 360*30/120=90 degrees.
There are two ways for the driver advisor to get the traffic light cycling information:
   1. The wireless broadcasts from the broadcast unit.
2. The message from the communicators.
b) The distance to the traffic light. This information will come from the communicators.
c) The identification number of the traffic light. This information will come from the communicators.
d) The speed limit. This information will come from the communicators.
e) The speed of moving sections. This will come from the communicators.

The driver advisor unit has a sensor or antenna to receive messages. The driver advisor only uses messages with the identification number for the traffic light in front. Once the vehicle reaches the traffic light, the identification number will be saved in memory to distinguish the messages for the traffic light in front from the messages for the traffic light at the back. The driver advisor has a microprocessor to do calculation.

When the vehicle passes by a communicator, it will receive a message frame from the communicator. At this moment, the driver advisor will update the distance to the traffic light by the received messages from the communicator. The driver advisor will continuously update the distance by calculation. The driver advisor is connected to the speed sensor in the wheel or connected to the vehicle system to get information about the vehicle speed for calculation of the distance. The driver advisor also continuously calculates the positions of the moving sections.

### Communicator

The speed limit, the speed of the moving sections, the traffic light identification number, and the distance from the traffic light are constants for a specific communicator.

If the driver advisor receives traffic light cycling messages from communicators, the communicators are connected with the traffic light by wires to synchronize with the traffic light periods. In this case the communicators have to calculate the phase of the traffic light cycle. And there is no need for the broadcast unit.

If the driver advisor receives traffic light cycling message from broadcast unit, there is no need for a communicator connected to the traffic light. The carrier signal for messages from communicators to the vehicles may be infrared ray, microwave, laser, and radio frequency.

### Broadcast Unit

A broadcast unit synchronizes with the traffic light and calculate the phase of the traffic light periods.

It broadcasts information about the traffic light cycling information and the traffic light identification number.

### CROSS REFERENCE TO RELATED APPLICATION

This application is a continuation-in-part of application of Ser. No. 10/894.922

What is claim is:

1. A Traffic Light Prediction System that helps a driver to save gasoline by avoiding red lights or by decelerating before a red light, said traffic light prediction system defines three kinds of moving sections, red sections, green sections, and yellow sections, said moving sections are positioned at varying distances along the street extending out from the traffic light, the length of said moving sections is related to future periods of the traffic light colors, each kind of said moving sections represents at least one future color of the traffic light, the movement of said moving sections is synchronized with the traffic light color periods so that the time each of said moving sections reaches the traffic light is the time that the traffic light changes the color to the color that said each moving section represents, comprising:
a) One driver advisor unit for each vehicle, said driver advisor gives video and audio advise to the driver;
b) At least one communicator, said communicators send messages to said driver advisors about the traffic light cycling information, distance of said communicator to the traffic light, the traffic light identification number, speed of said moving sections, and speed limit for the street;
c) At least one broadcast unit, said broadcast unit broadcasts the traffic
d) light cycling information and the traffic light identification number;

2. The Traffic Light Predication System of claim 1, wherein the messages that each of said communicators sends to said driver advisor units comprise:
a) the traffic light cycling information comprising:
1. The period of green light;
2. The period of yellow light;
3. The period of red light;
4. The phase of the traffic light cycle;
b) the distance from said each of said communicators to the traffic light;
c) the identification number of the traffic light to which said communicators are guiding to;
d) the speed of said moving sections;
e) the speed limit;

3. The Traffic Light Predication System of claim 1, wherein the messages that said broadcast unit broadcasts comprise:
a) the traffic light cycling information comprising:
1. the period of green light;
2. the period of yellow light;
3. the period of red light;
4. the phase of the traffic light cycle;
b) The identification number of the traffic light;

4. The Traffic Light Predication System of claim 1, wherein said driver advisor unit comprises:
a) at least one sensor or antenna;
b) at least one microprocessor;
c) at least one video device, displaying the positions of the vehicle, the traffic light, and said moving sections;
d) at least one audio device, giving advise of how to change the vehicle speed;

5. The Traffic Light Predication System of claim 1, wherein the carriers of messages sent by said communicators comprise:
a) infrared rate;
b) radio frequency;
c) microwave;
d) laser;
